(19) United States
(12) Patent Application Publication
(10) Pub. No.: US 2007/0211143 A1
(43) Pub. Date: Sep. 13, 2007

(54) SYSTEMS AND METHODS FOR PROMPT PICTURE LOCATION TAGGING

(76) Inventors: Keith J. Brodie, Irvine, CA (US); Peter R. Fowler, Poway, CA (US); David A. Tuck, Costa Mesa, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/684,331

(22) Filed: Mar. 9, 2007

Related U.S. Application Data
(60) Provisional application No. 60/781,131, filed on Mar. 10, 2006.

(51) Int. Cl. H04N 7/18

(52) U.S. Cl. 348/141; 348/142

(57) ABSTRACT

A picture location tagging system and method. A system in accordance with the present invention comprises a processor, an image sensor, coupled to the processor, for recording the image, a location generator, coupled to the processor, for receiving location-determining signals from a location-determining system, and a memory, coupled to the processor, for storing the image and for storing the location-determining signals, wherein the location-determining signals are associated with the image.

### CROSS-REFERENCE TO RELATED APPLICATIONS

This application claims the benefit under 35 U.S.C. Section 119(e) of co-pending and commonly-assigned U.S. provisional patent application, Ser. No. 60/781,131, filed Mar. 10, 2006, entitled “SYSTEMS AND METHODS FOR PROMPT PICTURE LOCATION TAGGING,” by Keith J. Brodie et al., which application is incorporated by reference herein.

### BACKGROUND OF THE INVENTION

1. Field of the Invention

The present invention relates generally to the Global Positioning System (GPS), and in particular, to systems and methods for augmenting digital pictures with a location tag.

2. Description of the Related Art

The use of GPS in consumer products has become commonplace. Hand-held devices used for mountaineering, automobile navigation systems, and GPS for use with cellular telephones are just a few examples of consumer products using GPS technology.

Cameras with embedded GPS receivers, or other satellite positioning system receivers, are also available today. These cameras are capable of producing a position tag for pictures taken, such that the location at which the picture was taken can be stored in the memory of the camera along with the image data. Provision for the storage of such position information had been made in some image file formats. For example, the Exchangeable Image File Format for Digital Cameras (EXIF) version 2.2 defined by the Japan Electronics and Information Technology Industries Association (JEITA) standard CP-3451 of April 2002 calls out GPS tags to store position information in the image file (Table 12, pp. 46), including latitude, longitude, and altitude. The definition of the tags in the standard uses the acronym GPS, but generically, the positioning function can be supported by any satellite positioning system, including, for example, Galileo.

The same position storage fields can be used independent of the particular satellite positioning system employed. When the image file is displayed in an application, the location at which the picture was taken can be displayed on a map, and images can be grouped by location.

One deficiency in the current art is that the satellite positioning receiver may not have a position fix available at the time a picture is taken. In the case of a GPS receiver, for example, a camera may be stored for sometime with power off. When the camera is then powered up, the receiver begins to acquire satellites and decode the satellite ephemerides required to compute position. During this acquisition and data-decoding interval, the GPS receiver does not yet have a position fix. A snapshot can be taken during this time, and the camera immediately powered-off and put away, preventing the completion of the acquisition, data-decoding, and position fix process. In this case there is no position tag available for the picture.

If the camera remains powered-on the satellite positioning system receiver can continue the acquisition and data-decoding process, potentially getting a fix, however, this additional on-time and the delay in tagging the picture are both deficiencies in the current art, as it consumes power, and if the camera is moving, the fix is not at the location the picture was taken.

The satellite positioning receiver in the camera in the current art has the capability to provide real-time positioning information once acquisition is complete and a sufficient number of satellites are in track. This capability, however, is not required for the picture-tagging function, the location of the camera at the time the picture was taken is not needed or used in the camera, it is needed afterwards, when the recorded picture file is displayed. To the extent that the real-time capability involves hardware in the camera beyond the minimum necessary—it represents a deficiency in the camera design; it costs more than it could, and uses more power than it could, relative to a design minimized to provide the necessary function.

It can be seen, then, that there is a need in the art to allow for tagging of a picture with GPS data even when the picture was taken without acquiring a GPS position fix.

### SUMMARY OF THE INVENTION

To minimize the limitations in the prior art, and to minimize other limitations that will become apparent upon reading and understanding the present specification, the present invention describes a prompt picture location tagging system and method. A system in accordance with the present invention comprises a processor, an image sensor, coupled to the processor, for recording the image, a location generator, coupled to the processor, for receiving location-determining signals from a location-determining system, and a memory, coupled to the processor, for storing the image and for storing the location-determining signals, wherein the location-determining signals are associated with the image.

Such a system further optionally includes the location generator being a GPS receiver, the memory storing raw GPS signals, the memory storing latitude and longitude data that has been determined from the location-determining signals, the location-determining signals being insufficient to determine a location for the image that the location-determining signals are associated with, and location-determining signals from another image being associated with the image upon determination of a common location for the image and the another image.

The systems and methods described make use of a set of samples, preprocessed and stored at the time the snapshot is taken. These preprocessed samples are used at a later time, either in the camera or in another device, to determine the location at which the picture was taken. The post-processed samples make use of stored ephemeris data to compute the position at the time the picture was taken. Ephemeris storage can take place in the camera taking the picture, or by another receiver or receivers, operating in other locations, from which ephemeris records are being stored to support post-processing of samples.

### BRIEF DESCRIPTION OF THE DRAWINGS

Referring now to the drawings in which like reference numbers represent corresponding parts throughout:

FIG. 1 is a functional block diagram of the camera element of a first embodiment of the invention;

FIG. 2 is a functional block diagram of the camera element of a second embodiment of the invention;

FIG. 3 is a functional block diagram of the camera element of a third embodiment of the invention in which a GPS receiver and a separate 1-bit GPS signal sampling system are available to the microprocessor to provide either a position solution or a set of samples to be associated with an image file;

FIG. 4 is a functional block diagram of an embodiment of the invention in which the camera communicates with a computer to upload the image and sample file, and the computer communicates with an ephemeris server over the Internet to obtain data necessary to determine location from the samples;

FIG. 5 is a top-level data flow diagram of a prior art camera with position tagging capability;

FIG. 6 is a top-level data flow diagram for a first embodiment of the invention in which the image and SPS samples processed and stored in a file are further processed at a later time to produce an image file with a position tag;

FIG. 7 is a flow-chart for a process operating on a microprocessor in the camera element of the invention;

FIG. 8 is a flow-chart for a process by which image files stored with SPS samples are post-processed to produce an image file with a position tag;

FIG. 9 is an embodiment of the positioning information database scheme used to store position fixes and SPS samples in accordance with the present invention; and

FIG. 10 illustrates an example of using before and after pictures in accordance with the present invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

Nomenclature and Figure Conventions

In the present specification, SPS is used to refer to a satellite positioning system. Examples of SPS's include the Global Positioning System (GPS), Galileo, and GLONASS, or any system which makes use of transmissions from more than one Earth-orbiting satellite to make a position determination. Combinations of such systems are also included in the definition of SPS.

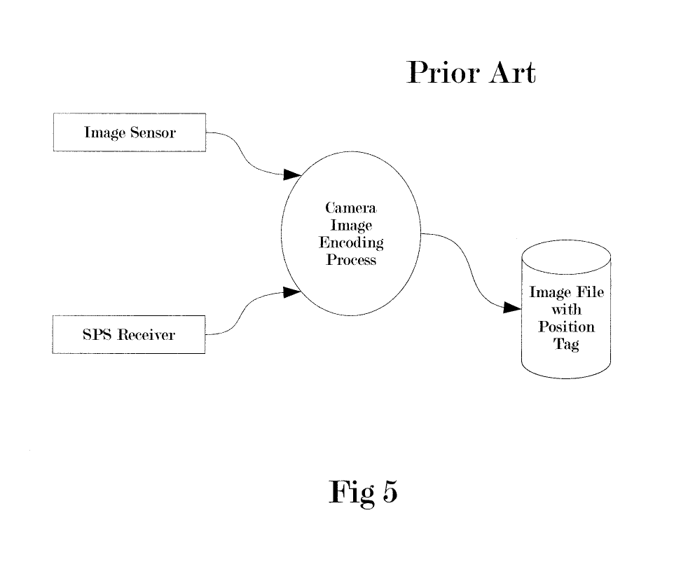

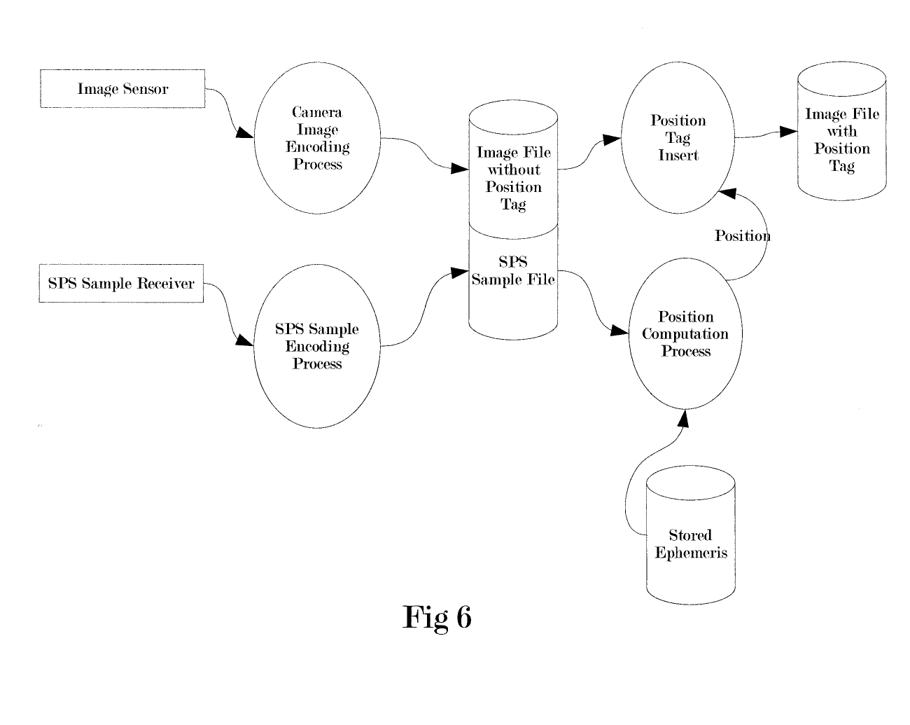

In the data flow diagrams, FIGS. 5 and 6, rectangles represent devices with data outputs, circles represent data-handling processes operating on a processor or combination of processors, and cylinders represent data storage in a collection referred to as a file. The physical medium of data storage can be flash memory, magnetic-disk, or any other device capable of non-volatile storage of digital data.

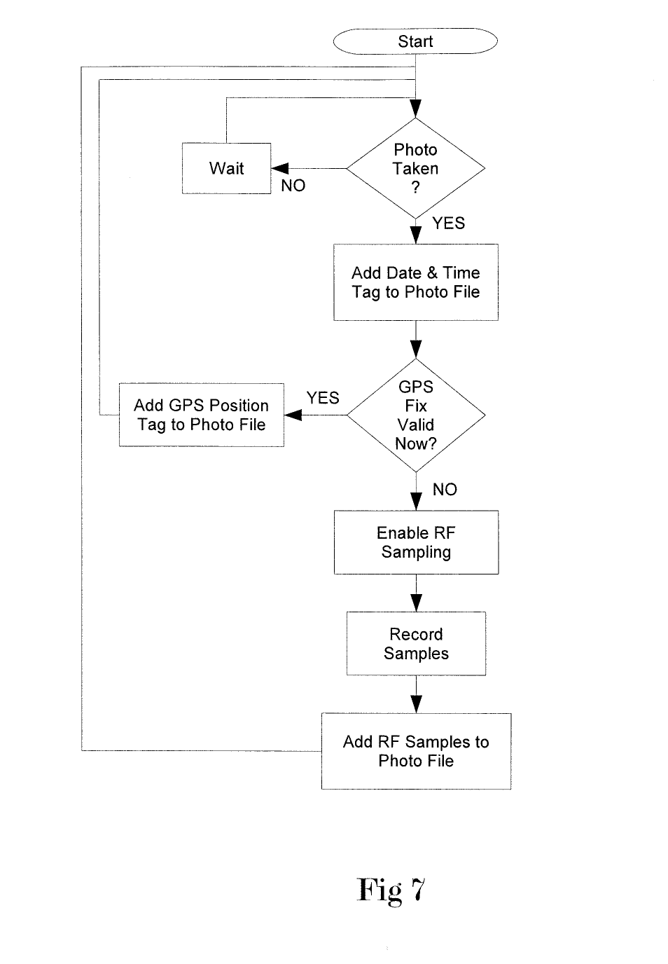

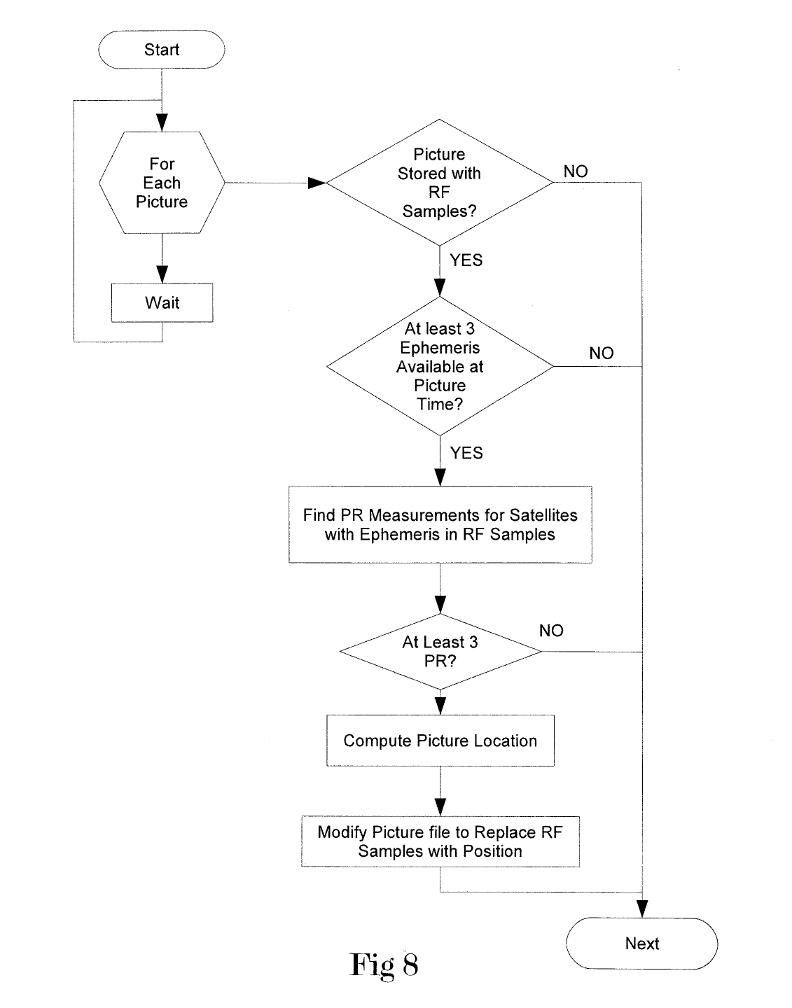

In the flowcharts, FIGS. 7 and 8, rectangles represent processing steps, diamonds represent decisions, ovals represent terminal points, and a hexagon is used to indicate the start of a loop, the end of the loop being indicated with a ‘Next’ terminal point.

Camera Element

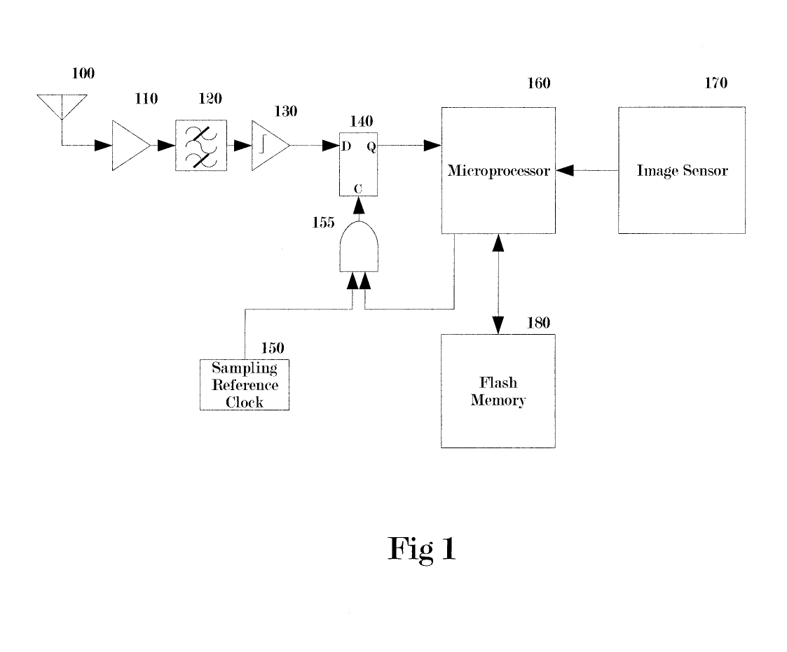

FIG. 1 is a functional block diagram of the camera element of a first embodiment of the invention.

A camera in accordance with the present invention has the capability to take samples of the signals from the SPS and store them. SPS signals are received by the antenna 100 and fed to a low-noise amplifier 110, then a bandpass filter 120, and then to a comparator 130 which is acting as a 1-bit digitizer.

The 1-bit samples are clocked with the Sampling Reference Clock 150 through the flip-flop 140, and the resulting clock-synchronized bit-stream is read by the microprocessor 160. The microprocessor 160 assembles the samples into a sample record and stores them in the flash memory 180. The sample record is stored in a manner such that it can be correlated with an image file resulting from the microprocessor 160 reading the output of the image sensor 170.

In one embodiment of the storage mechanism, the SPS samples are stored in a file with the same name and a different extension as the image file. In a second embodiment of the storage mechanism, the SPS samples are stored in the same file as the image, in a custom, or user-defined record in the file. In a third embodiment, the SPS samples are stored in different files with unrelated names, but the microprocessor 160 also maintains an index file which records the name of the SPS sample file associated with each image file.

In the embodiment of FIG. 1, when used with L1-band GPS as the SPS, the desired signal to be sampled is at 1575.42 MHz. The bandpass filter 120 limits substantially signal energy at frequencies outside of a passband around the center frequency of 1575.42 MHz. The bandwidth of the filter passband is approximately 4 MHz in this example. The Sampling Reference Clock 150 rate in this example is at least 2 MHz, which is the necessary minimum to collect the spread-spectrum signal broadcast by GPS at L1. This is therefore, a bandpass-sampling embodiment.

Alternative embodiments within the scope of the invention include systems which make use of one or more down-conversion stages before sampling. Down-conversion is accomplished by mixing the received signal with a local oscillator signal to get a product signal at the difference frequency. Another variation is using more than 1-bit to sample the signal, and sampling complex mixer products (I, Q)—rather than single-ended sampling as shown in FIG. 1.

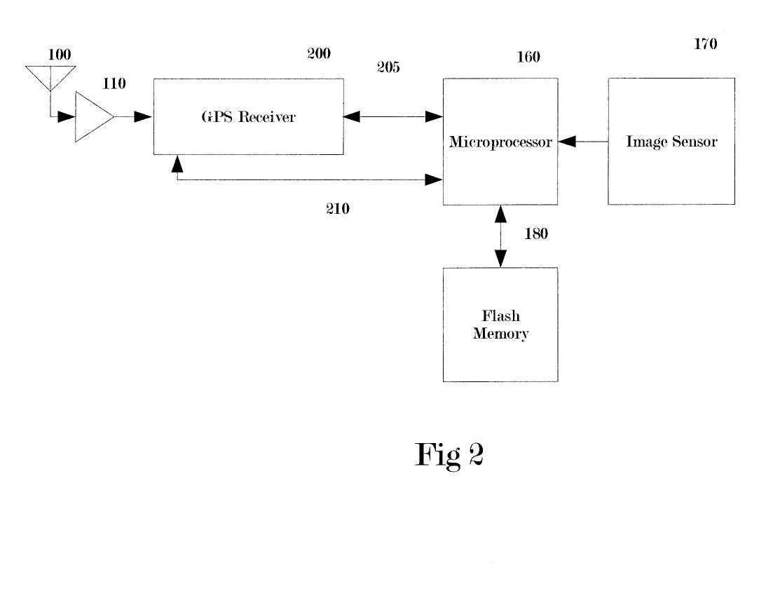

FIG. 2 is a functional block diagram of the camera element of a second embodiment of the invention.

In FIG. 2, antenna 100 feeds a signal to the low-noise amplifier 110 which in-turn feeds the signal to a GPS receiver 200. The GPS receiver 200 has a GPS fix available at some times, and at other times it does not. The GPS receiver 200 has two communication links with the microprocessor 160, the main link 205 and an auxiliary link 210.

The status of the GPS receiver 200, whether or not the fix is available, and the fix itself if available, are communicated to the microprocessor 160 over the main link 205, typically a serial data link such as RS-232, SPI, I2C (I2C is a trademark of Koninklijke Philips Electronics NV) or USB. GPS samples are transmitted to the microprocessor over the auxiliary link 210. The samples are extracted from the GPS receiver 200 in after digitization. This link 210 requires a sufficient data-rate to support a sample rate of at least 2 Mbit/second for GPS. It may be a serial or parallel link.

Other embodiments of the invention include a GPS receiver configured to send both position fixes and samples over the main link 205, obviating the need for the auxiliary link 210. A GPS configured to store some portion of the sample stream in a buffer for transmission over either the main 205 or auxiliary 210 links are also within the scope of the invention.

In contrast to the camera element of FIG. 1, the camera element of FIG. 2 is capable of providing a position fix for location tagging of an image file directly from the SPS receiver. The camera element embodiment of FIG. 1 does not contain a complete GPS receiver, and can be used only to provide a set of samples from which the position fix for tagging the image can later be determined.

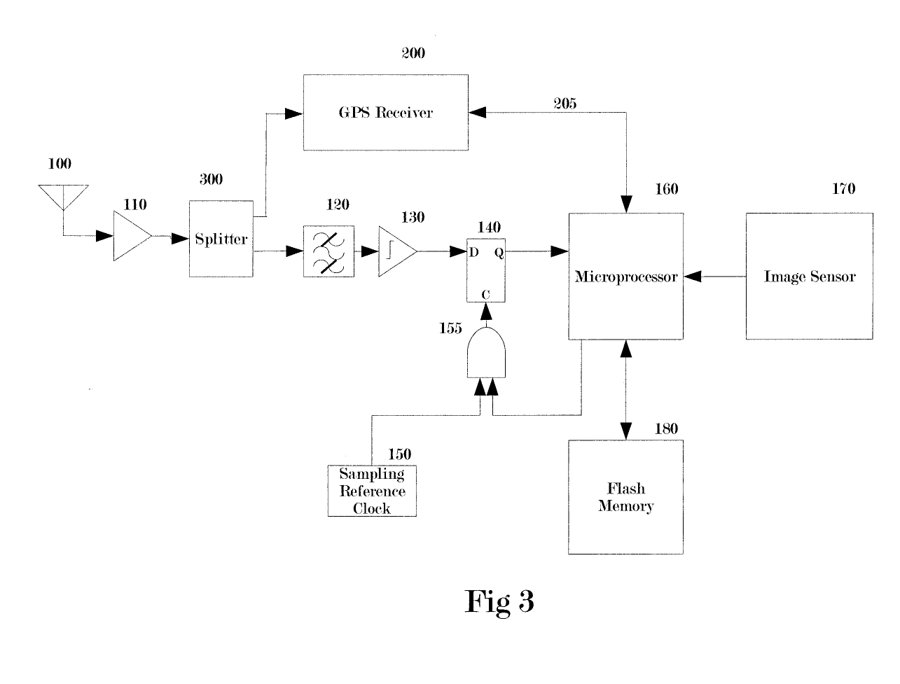

FIG. 3 is another embodiment of the camera element of the present invention, in which the received signal is split for processing by both a signal sampling circuit (120, 130, 140) and a GPS receiver 200. If the receiver has a fix, an image file position tag can be added immediately after the picture is taken, if not, a sample record is taken to support post-processing to determine the position tag.

System Diagrams

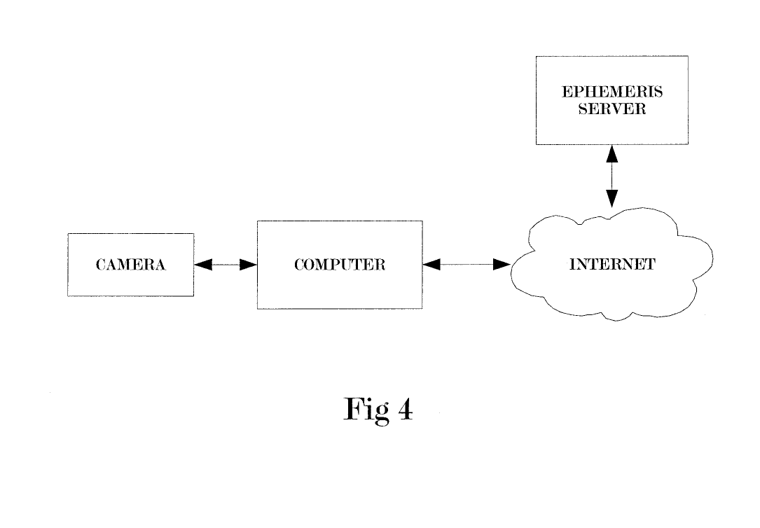

FIG. 4 is a functional block diagram of an embodiment of the system of the present invention. Camera (400) downloads image files with embedded or associated sample records to computer (410). A computer program on computer (410) processes the sample file to extract measurements and compute a position fix. In order to do that, the computer program must have access to the ephemeris indicating the position of the satellites at the time the samples were taken. In this embodiment those are retrieved from an ephemeris server available through an Internet connection. A database suitable for use in this application is available form the National Geodetic Survey office of the commerce department, and can be accessed through this URL: http://www.ngs.noaa.gov/GPS/GPS.html. Other databases can be used, and combinations of such databases can be used to maximize the availability of suitable historical ephemeris record availability.

FIG. 5 is a top-level data-flow diagram describing the processing on a prior art camera equipped to provide position tags for pictures. The image is recorded from the image sensor, and the position fix is recorded from the SPS receiver. The fix is used to create a position tag for the image.

FIG. 6 is a top-level data-flow diagram for the present invention. The image sensor records an image that is processed to produce an image file as in the prior art. Additionally, the SPS samples are recorded for a time-interval starting at or near the time the picture was taken. The sample set is recorded in a fashion that it can be associated with the image file, either as a subset of the image file or in a separate file that can be associated with the image file. At some later time, either in the camera or after download to a computer, a position computation process uses the stored SPS samples and stored ephemeris records to compute a position. The position is inserted into the image file as a position tag element by the Position Tag Insert process.

Alternative Camera Storage Scheme

For a camera element of the present invention in accordance with the functional block diagram of FIGS. 2 or 3, the camera has a complete SPS receiver, and will be able to make position fixes if the camera keeps power to the SPS receiver on long enough and enough satellites are visible. If the camera is powered down during acquisition or processing of the SPS data, the SPS receiver may retain power for a certain amount of time after camera power down to try to complete the acquisition and/or position fix. If the camera is powered down from a cold start of the SPS receiver, the SPS receiver may need power to remain on for approximately 30 seconds to complete the acquisition/position fix; if the SPS is performing a partial acquisition, only one or two seconds may be needed. Under these conditions, the camera will be able to tag some images directly with position, and in other cases is not able to do so and therefore stores SPS samples.

A position database can be maintained which takes advantage of the availability of both types of information being available to minimize the amount of SPS sample time required, and allow for post-processing of SPS samples onboard the camera to produce and store a position fix, whereupon the SPS samples can be deleted, saving storage space in the camera.

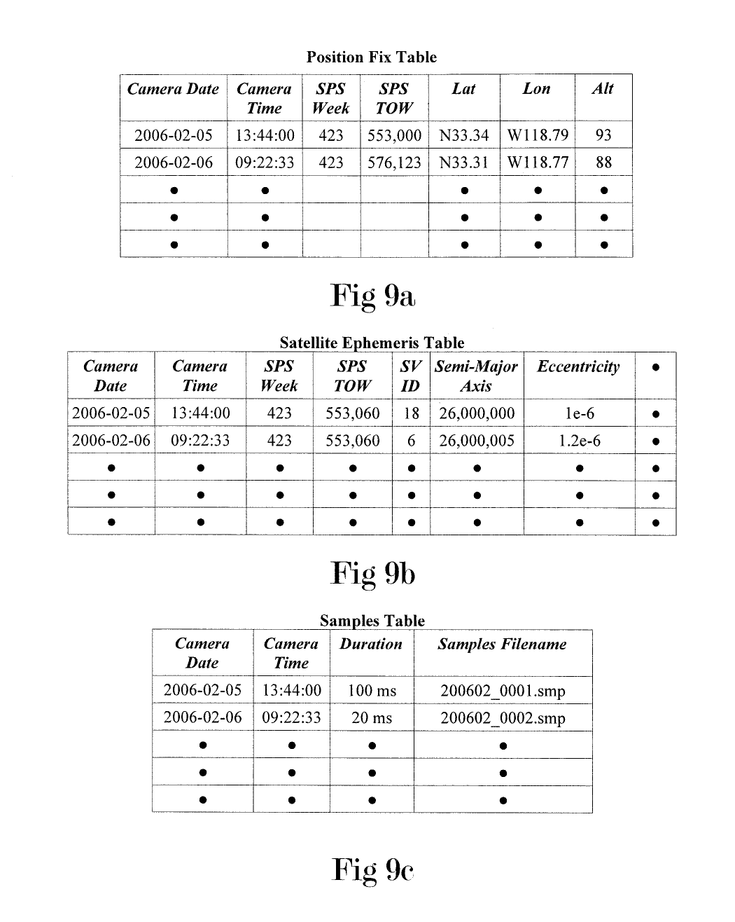

Referring to FIG. 9, periodically and whenever a picture is taken, if the SPS receiver has a fix available, the fix is recorded in the position fix table. The fix record includes the camera's data and time, the data and time as solved for with the SPS, and the position. The position fix table shown uses a latitude, longitude and altitude format to store position—which is by way of example; any format for storing an Earth-relative position is in accordance with the present invention. The Camera Data and Camera Time field formats shown are also by way of example, and the SPS Week and SPS Time-of-Week (TOW) are by way of example as well. Other formats are envisioned as being within the scope of the present invention.

In the process of making position fixes, the SPS will decode satellite ephemeris data from the signals received. These ephemeris records store information required to compute the position of the satellite at the time the transmission is made. In the case of GPS, the ephemeris data typically comprises the square root of the semi-major axis, eccentricity, and other orbital elements. The satellite ephemeris table stores these records, with the column of dots on the right-hand side of the table representing the rest of the orbital elements and time tags not listed explicitly.

The third table in FIG. 9 is a table identifying the SPS sample files stored by the camera. These are stored with the camera data and time as index fields because the SPS system time may not be available. A duration field is shown in the table. Alternatively the duration can be determined from the size of the file. Depending on the specific nature of the non-volatile storage system on the camera, the filename could be an address pointer, a file index number, or any other indicator that allows the camera processor to determine the location of the file in the non-volatile memory for retrieval.

Sampling Duration

The SPS sampling duration must be long enough to provide a sufficient coherent integration interval to allow for detection of the signal and determination of the pseudo-noise code phase. The duration does set a limit on how sensitivity of the method. Another limit on the duration of the SPS sampling time is what ambiguity can be allowed in the resulting code-phase measurements. For the GPS C/A code, by example, the code repeats itself every millisecond. Determination of the code-phase alone determines the pseudo-range only to within a one millisecond ambiguity, approximately 30 km.

If there are a sufficient number of measurements available, and an approximate position is known, this is enough information to solve for the position. If, however, there are a lesser number of measurements available or no prior position information, it is necessary to detect the data-bit edge in the C/A code sequence. This occurs every 20 ms. Since not all data-bit edges actually have a phase-change, multiple data-bit intervals need to be observed to have a high probability of being able to determine a data-bit edge. In the samples table of FIG. 9, the first record indicates the sampling duration was 100 ms, long enough to allow for a high-probability that data-bit edges can be determined for each of the satellites signals in the record.

In the second row, a 20 ms sample duration was taken, indicating that the camera is making use of the fact that it has a recent long-duration sample from which it can extract timing to within 1 ms accuracy, or a recent position fix from which can be used with 1 ms ambiguous code-phases to determine a subsequent fix. It is a feature of the present design that the sampling duration is variable and responsive to the availability of prior position fixes, prior samples taken, or both.

The discussion above on the adaptation of the sampling duration was directed towards GPS by way of example. A similar sampling duration decision strategy applies to any SPS wherein the satellites transmit a signal modulated with a pseudo-noise sequence and further modulated with a data sequence at a lower rate. Galileo, GLONASS, and signals from the GPS satellites other than L1 C/A all constitute SPS with these characteristics.

Power-Up Sequence

Referring to FIG. 1, the Sampling Reference Clock 150 determines the interval between samples. The performance of the complete system is enhanced when this clock is at a fixed frequency and minimum jitter. Typically the clock will be driven by a temperature-controlled crystal oscillator (TCXO). The TCXO has a warm-up period, a time interval from application of power until the output frequency is stabilized. In order to get best performance from the system, the TCXO can be powered-up first, allowed to stabilize, and then used to drive the sampling rate. In the embodiment of FIG. 1, the Sampling Reference Clock (150) controls the sampling rate by clocking the flip-flop 140.

There are also typically components with short warm-up times in the LNA 110, settling time from the initial voltage applied to the filter 120, and warm-up and offset-cancellation settling time in the comparator 130. These characteristics suggest that the performance of the sampling sub-system in the camera element can be maximized by powering up the components prior to clocking in the samples.

Another approach to preventing oscillator warm-up from degrading system performance is to leave the oscillator on continuously, but this is generally not feasible because the battery energy consumed limits the camera's usability.

In the embodiment of FIG. 2, the sampling clock is part of the SPS receiver 200. The same method may be used within the SPS receiver to stabilize the sampling frequency before taking the SPS samples.

SPS Sample Processing

In order to produce a position fix from an SPS Sample segment, the segment must be processed to do several things. First, the segment is processed to find satellite signals in the SPS Sample segment. Then, the pseudo-noise code phase of the signal is determined at a reference time known relative to the start-time of the sample segment. The data-bit edge of the signal is determined at a reference time known relative to the start-time of the sample segment, and pseudo-range measurements are constructed by differencing the time-of-arrival of the signal as indicated by the code phase and data-bit edge with the camera time estimate. The position of the satellites at transmission time is then determined, and the set of equations resulting from equating the measured pseudo-ranges is solved with the predicted range to the satellite plus the error in the camera time estimate, wherein the range estimate may include corrections for tropospheric refraction and ionospheric dispersion.

Finding Satellites in the SPS Sample Segment

There are a number of known methods for finding SPS signals in receivers. A description of some of the prior art acquisition process and a comparison of some detector types for GPS is given in Understanding GPS: Principles and Applications, Elliot D. Kaplan, Ed., © Artech House, Inc., Norwood MA. 1996, Section 5.1.7 which is incorporated herein by reference. Any of these can be adapted for use in processing an SPS Sample Segment at a later time. The most elementary, brute-force method is to step through a set of possible PN code sequences, for each sequence stepping through possible starting code-phases, and for each code-phase, stepping through potential doppler frequencies. For each of these trials, characterized by a PN-code, a code phase, and a frequency, an integration is performed to determine if the trial settings result in de-spreading a signal that exists in the SPS Sample Segment at a power level large enough to distinguish it from the noise. This is no different from sequential acquisition in an SPS receiver, other than the fact that each new trial begins it's integration at the start of the SPS Sample Segment previously recorded, whereas, in an actual sequential acquisition SPS receiver, subsequent trials begin on samples currently being collected, rather than saved samples.

Alternative methods for finding signals in the sample set include offsetting two copies of the sample set by a fraction of a chip and multiplying them element by element to obtain a product sample set. In the product set, white-noise is attenuated because the offset introduces a time-difference, and white noise is uncorrelated in time. Simultaneously, the product partially cancels binary-phase-shift-keying applied to the carrier. An FFT applied to the product sample stream returns the frequencies of the signals present in the sample set. These frequencies can be used to constrain the previously described brute-force search for the code phase.

Frequency domain techniques for search in the code space are described in the prior art as well. All of these prior-art techniques, as applied to the saved Sample set, are within the scope of the present invention.

Position Tagging with a Synthetic Fix

If the SPS receiver has no capability to store SPS samples, or if the SPS sample associated with a particular image does not yield enough information to produce a position fix, it is still desirable to have the ability to tag a picture with a position.

The present invention also contemplates a synthetic fix to generate a position tag. If a position tag was taken before or after the untagged image time; within a settable time-window, the position fix closest in time and within the time window is used as a synthetic fix for the image without a fix. The synthetic fix can be determined and applied to the image file either in the camera, or in processing applied outside the camera. If the format of location information storage in the camera follows the schema of FIG. 9, the fix table can be used to determine if there is a suitable fix (within the time window), and find the closest fix.

Furthermore, if there is an SPS sample set for an untagged image, it may yields some signal information that can be used to determine the reasonableness of a synthetic fix. For example, if we assume an SPS sample set was taken with an image, and from it we can only find satellites 7 and 12, that is insufficient information of satellites to produce an independent position fix for that sample set. If, however, we have another SPS sample set taken 10 minutes earlier, and if, in the sample set associated with the earlier image, satellites 7 and 12 were also visible, that is an indicator that it is reasonable to assume the later image was taken in substantially the same location.

A second example will illustrate a more advanced test on the synthetic fix. Again we assume an SPS sample set has been taken, but there is insufficient signal information found to determine a position fix from the sample set. As above, we have satellites 7 and 12, their code phases modulo 1 millisecond, and their Doppler frequencies. If we have a synthetic fix for this time, we can check it by comparing the predicted Doppler frequency difference between satellites 7 & 12 using the synthetic fix and the satellite ephemeredes. If the predicted Doppler difference agrees with the measured Doppler difference at the time of the synthetic fix, we have high confidence that the synthetic fix is correct, and that is the location from which the picture was taken.

General Position Tagging Using Prior and after Pictures

For what ever reason should an image not have a position fix associated with it when it is stored in the digital still camera then a user could use the following methodology to assign a position fix.

Image are recorded with a time stamp by the digital still camera. The images are then downloaded to a personal computer. Software would then display three images:
1) The image that does Not have a position fix associated with it—called “No Fix Image.”
2) The image that was taken prior to “No Fix Image” that contains a position fix and in terms of time stamping is closest to the “No Fix Image”—called “Prior Image with Fix.”
3) The image that was taken after “No Fix Image” that contains a position fix and in terms of time stamping is closest to the “No Fix Image”—called “After Image with Fix.”

The user could then assign a position fix to the “No Fix Image” by choosing either the “Prior Image with Fix” of the “After Image with Fix” and having the software transfer the position fix to the “No Fix Image”.

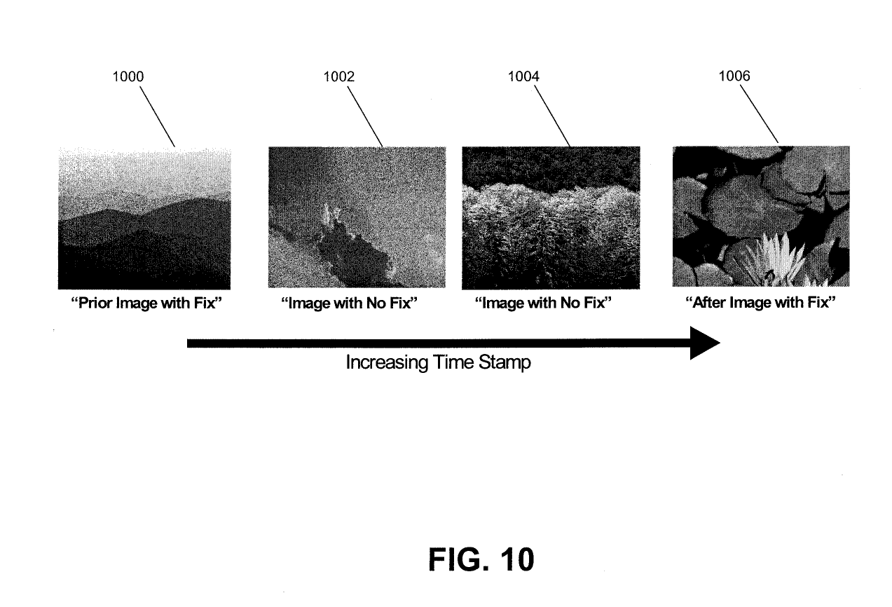

FIG. 10 illustrates an example of using before and after pictures in accordance with the present invention.

Image 1000 is an image that occurs first in time with respect to images 1002-1006, as determined by a time stamp attached to images 1000-1006. Other methods of determining which picture was taken first may be used without departing from the scope of the present invention. Image 1000 comprises an location “fix” or other location tag to indicate the location of image 1000.

Image 1002 was taken after image 1000, and there is no location fix associated with image 1002. Similarly, image 1004 has no location fix associated with image 1004. Image 1006, which was taken after images 1000- 1004, does have a location tag associated with the image 1006.

As such, when images 1000-1006 are downloaded to a personal computer, or other storage device, a user can interact with images 1000-1006, as is often done with images 1000-1006 to provide better color contrast, color balancing, or other photographic techniques, however, in the present invention, the missing position information can be provided by a user that can assist the SPS system with location tags. If the user knows, for example, that image 1002 was taken at the same place as image 1000, then the user can inform the computer to insert the location from image 1000 to the image file of image 1002.

Similarly, image 1004 may have been taken at the same location as image 1000, or at the same location as image 1006. When manipulating the image 1004 data, the user can apply the proper location tag to image 1004. If image 1004 was not taken at the same location as either image 1000 or image 1006, the user can leave the image location data blank, or use external data or other data to fill in the proper location for image 1004.

Conclusion

In summary, the present invention describes a prompt picture location tagging system and method. A system in accordance with the present invention comprises a processor, an image sensor, coupled to the processor, for recording the image, a location generator, coupled to the processor, for receiving location-determining signals from a location-determining system, and a memory, coupled to the processor, for storing the image and for storing the location-determining signals, wherein the location-determining signals are associated with the image.

Such a system further optionally includes the location generator being a GPS receiver, the memory storing raw GPS signals, the memory storing latitude and longitude data that has been determined from the location-determining signals, the location-determining signals being insufficient to determine a location for the image that the location-determining signals are associated with, and location-determining signals from another image being associated with the image upon determination of a common location for the image and the another image.

The documents “uN3020 Internal Sample Capture Mode,” and “Partial Acquisition Method,” which are attached to provisional application Ser. No. 60/781,131, are herein incorporated by reference.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and the equivalents thereof.

What is claimed is:

1. A system for providing image location data for an image taken with a camera, comprising:
a processor;
an image sensor, coupled to the processor, for recording the image;
a location generator, coupled to the processor, for receiving location-determining signals from a location-determining system; and
a memory, coupled to the processor, for storing the image and for storing the location-determining signals, wherein the location-determining signals are associated with the image.

2. The system of claim 1, wherein the location generator is a GPS receiver.

3. The system of claim 2, wherein the memory stores raw GPS signals.

4. The system of claim 2, wherein the memory stores latitude and longitude data that has been determined from the location-determining signals.

5. The system of claim 1, wherein the location-determining signals are insufficient to determine a location for the image that the location-determining signals are associated with.

6. The system of claim 5, wherein location-determining signals from another image are associated with the image upon determination of a common location for the image and the another image.

7. A device which provides image location data for an image, comprising:
a camera;
a processor, coupled to the camera;
a location generator, coupled to the processor, the location generator receiving location-determining signals from a location-determining system; and
a memory, coupled to the processor, the memory storing the image and the location-determining signals, wherein the location-determining signals are associated with the image.

8. The device of claim 7, wherein the location generator is a GPS receiver.

9. The device of claim 8, wherein the memory stores raw GPS signals.

10. The device of claim 8, wherein the memory stores latitude and longitude data determined from the location-determining signals.

11. The device of claim 8, wherein the location-determining signals are insufficient to determine a location for the image that the location-determining signals are associated with.

12. The device of claim 11, wherein location-determining signals from another image are associated with the image upon determination of a common location for the image and the another image.
